(19) United States
(12) Patent Application Publication
(10) Pub. No.: US 2021/0178462 A1
(43) Pub. Date: Jun. 17, 2021

(54) MAGNESIUM ALLOY STRUCTURAL MEMBER

(71) Applicant: SUMITOMO ELECTRIC INDUSTRIES, LTD., Osaka-shi, Osaka (JP)

(72) Inventors: Yoko MAEDA, Itami-shi, Hyogo (JP); Motoyoshi TANAKA, Itami-shi, Hyogo (JP); Kenichi SUZUKI, Itami-shi, Hyogo (JP)

(73) Assignee: SUMITOMO ELECTRIC INDUSTRIES, LTD., Osaka-shi, Osaka (JP)

(21) Appl. No.: 16/479,661

(22) PCT Filed: Dec. 13, 2017
(86) PCT No.: PCT/JP2017/044674

§ 371 Date: Jul. 22, 2019

(30) Foreign Application Priority Data
Feb. 1, 2017 (JP) 2017-017038

(51) Int. Cl. B22D 21/04; C22C 23/02; B23C 3/12; B22D 11/00

(52) U.S. Cl. CPC B22D 21/04; B22D 11/001; B23C 3/12; C22C 23/02

(57) ABSTRACT

A magnesium alloy structural member includes an alloy substrate that includes a sheet-shaped portion consisting of a magnesium alloy corresponding to an AZ91 alloy under the standards of American Society for Testing and Materials. The alloy substrate has a surface, a part of which is a mirror-finished portion having a surface roughness Ra of less than 0.3 μm.

### TECHNICAL FIELD

The present invention relates to a magnesium alloy structural member. This application claims priority on the basis of Japanese Patent Application No. 2017-017038 filed Feb. 1, 2017, the entire contents of which are incorporated herein by reference.

### BACKGROUND ART

PTL 1 discloses, as a magnesium alloy structural member having highly metallic texture, a structural member including a surface-treated portion subjected to a surface treatment such as diamond cut, hairline finish, etching processing, or the like, and a transparent coating layer formed on a substrate including the surface-treated portion. Specifically, this magnesium alloy structural member is a rectangular parallelepiped box obtained by performing hot press forming on a rolled sheet composed of a magnesium alloy having a composition corresponding to AZ91 alloy, in which the top face of this box is entirely subjected to diamond cut and is further covered with a transparent coating layer (Experimental Example 1 in PTL 1), or is subjected to, for example, hairline finish (Experimental Example 2 in PTL 1) or etching processing (Experimental Example 4 in PTL 1) instead of the diamond cut.

### CITATION LIST

### Patent Literature

PTL 1: Japanese Unexamined Patent Application Publication No. 2009-120877

### SUMMARY OF INVENTION

A magnesium alloy structural member of the present disclosure includes:

an alloy substrate that includes a sheet-shaped portion consisting of a magnesium alloy corresponding to an AZ91 alloy under the standards of American Society for Testing and Materials,

in which the alloy substrate has a surface, a part of which is a mirror-finished portion having a surface roughness Ra of less than 0.3 μm.

### BRIEF DESCRIPTION OF THE DRAWINGS

FIG. 1 is a schematic cross-sectional view of a magnesium alloy structural member according to embodiment 1.

FIG. 2 is a schematic partial cross-sectional view of a magnesium alloy structural member according to embodiment 2.

FIG. 3 is a schematic partial cross-sectional view of a magnesium alloy structural member according to embodiment 3.

FIG. 4 is a schematic partial cross-sectional view of a magnesium alloy structural member according to embodiment 4.

FIG. 5 is a schematic partial cross-sectional view of a magnesium alloy structural member according to embodiment 5.

### DESCRIPTION OF EMBODIMENTS

### Problems to be Solved by Present Disclosure

The magnesium alloy structural member described in PTL 1 has highly metallic texture due to the surface-treated portion. However, this magnesium alloy structural member has the entire top face (60 mm×90 mm) of the box subjected to one type of surface treatment, and the region having uniform appearance is relatively large. Thus, a magnesium alloy structural member having superior design is desirable.

Thus, one of the objects is to provide a magnesium alloy structural member that has highly metallic texture and an excellent design property.

### Advantageous Effects of Present Disclosure

The magnesium alloy structural member of the present disclosure has highly metallic texture and an excellent design property.

First, the contents of the embodiments of the present invention are listed and described.
(1) A magnesium alloy structural member according to one aspect of the present invention includes:

an alloy substrate that includes a sheet-shaped portion consisting of a magnesium alloy corresponding to an AZ91 alloy under the standards of American Society for Testing and Materials (ASTM),

in which the alloy substrate has a surface, a part of which is a mirror-finished portion having a surface roughness Ra of less than 0.3 μm.

The magnesium alloy corresponding to the AZ91 alloy under the ASTM standards refers to those alloys which contain elements (such as Zn and Mn) prescribed in ASTM in amounts within the prescribed ranges, as well as those alloys which contain additive elements described below in amounts within particular ranges in addition to the elements prescribed in ASTM and which have an Al content that satisfies 8.3 mass % or more and 9.5 mass % or less.

The surface roughness Ra refers to an arithmetic mean roughness (see JIS B 0601 (1994)).

The alloy substrate that includes a sheet-shaped portion refers to the case in which a sheet is directly used as the alloy substrate, the case in which the alloy substrate is a shaped body that has a three-dimensional shape formed by plastic-working at least part of a sheet or has a three-dimensional shape formed of a three-dimensional object formed of sheets by cutting work, for example. Examples of the shaped body include a box having a top face portion and side face portions extending from the top face portion, and a cylinder such as a circular cylinder.

A part of the alloy substrate of the magnesium alloy structural member is a mirror-finished portion having a surface roughness Ra as small as less than 0.3 μm and having metallic luster. Since the surface roughness Ra of the mirror-finished portion is very small and since only part of the alloy substrate is the mirror-finished portion, highly metallic texture is exhibited, and a design is created due to the contrast between the mirror-finished portion and a portion (a portion having a surface roughness Ra of 0.3 μm or more, this portion may be referred to as the “surrounding portion” hereinafter) other than the mirror-finished portion. Thus, the magnesium alloy structural member has highly metallic texture and an excellent design property. Moreover, since the magnesium alloy structural member includes an alloy substrate consisting of a magnesium alloy corresponding to the AZ 91 alloy, which has excellent corrosion resistance and strength, the magnesium alloy structural member also has excellent corrosion resistance and strength.

The inventors of the present invention have found that when a raw material consisting of a magnesium alloy corresponding to the AZ91 alloy and includes a sheet-shaped portion is used as the raw material, and the raw material is subjected to diamond cut under particular conditions described below, a mirror-finished portion having a surface roughness Ra of less than 0.3 μm can be formed. Examples of such a raw material include a continuously cast sheet manufactured by a continuous casting process, in particular, a twin-roll process, a rolled sheet obtained by subjecting this continuously cast sheet to plastic working such as rolling, and a shaped body manufactured by subjecting the continuously cast sheet or the rolled sheet to a secondary process such as press forming or cutting work. Thus, one of the conditions for achieving highly metallic texture and an excellent design property is that the magnesium alloy structural member consists of a magnesium alloy corresponding to the AZ91 alloy and includes a sheet-shaped portion.
(2) One example of the magnesium alloy structural member described above is as follows:

An embodiment in which the mirror-finished portion has a strip shape with a uniform width, and this width is 0.1 mm or more and 50 mm or less.

Since the mirror-finished portion of the aforementioned embodiment has a strip shape with a particular width, the design property is improved due to the contrast between the mirror-finished portion and the surrounding portion other than the mirror-finished portion, for example, a portion adjacent to the strip-shaped mirror-finished portion. Moreover, the aforementioned particular width is suitable for diamond cut; thus, the processing time for the diamond cut is not excessively long, and this embodiment offers excellent manufacturability.
(3) One example of the magnesium alloy structural member described above is as follows:

An embodiment that includes a transparent coating layer that continuously covers the mirror-finished portion and a portion adjacent to the mirror-finished portion.

In this embodiment, since there is a transparent coating layer, corrosion resistance can be improved while highly metallic texture and an excellent design property are maintained. In particular, since the transparent coating layer extends over the mirror-finished portion and the portion adjacent thereto, corrosion near the interface between the mirror-finished portion and the portion adjacent thereto in the alloy substrate can be prevented, and thus corrosion resistance is further improved. Thus, this embodiment offers highly metallic texture and an excellent design property for a long period of time.
(4) One example of the magnesium alloy structural member described above is as follows:

An embodiment in which the mirror-finished portion includes a chamfered portion obtained by C-chamfering a corner portion of the alloy substrate. The corner portion of the alloy substrate refers to a portion near a ridge line of a sheet when the sheet is directly used as the alloy substrate, and refers to a corner portion formed by bending a sheet at a particular angle when a shaped body is used as the alloy substrate.

Since the chamfered portion is the mirror-finished portion, the design property is further improved due to the contrast between the chamfered portion and the surrounding portions other than the chamfered portion, in particular, the two faces that connect to the chamfered portion.
(5) One example of the magnesium alloy structural member of (4) described above having the chamfered portion is as follows:

An embodiment that includes a protective layer that covers at least part of two faces that connect to the chamfered portion of the alloy substrate, but does not cover the chamfered portion; and

a transparent coating layer that continuously covers the chamfered portion and at least part of the protective layer.

In the embodiment described above, for example, a layer having a different color or transmittance from the transparent coating layer may be used as the protective layer so that the metallic texture and the design property can be further improved by the contrast between the chamfered portion equipped with the transparent coating layer and the two faces equipped with the protective layer. Moreover, since the transparent coating layer extends over the chamfered portion and the protective layer and covers a portion near the boundaries between the chamfered portion and the two faces in the alloy substrate, corrosion near the boundaries can be prevented, and corrosion resistance is excellent. The portions where both the transparent coating layer and the protective layer are present have superior corrosion resistance.
(6) One example of the magnesium alloy structural member (5) having the chamfered portion, the transparent coating layer, and the protective layer is as follows:

An embodiment in which the transparent coating layer continuously covers the chamfered portion and the entirety of the protective layer.

In the embodiment described above, the alloy substrate is covered with the transparent coating layer or both the transparent coating layer and the protective layer; thus, corrosion resistance is superior while highly metallic texture and an excellent design property are maintained.
(7) One example of the magnesium alloy structural member described above is as follows:

An embodiment in which the alloy substrate is one selected from a shaped body of a rolled sheet, a rolled sheet, a continuously cast sheet, and a shaped body of a continuously cast sheet.

The embodiment described above can be used in various applications as a sheet member or shaped member having highly metallic texture and an excellent design property. Moreover, this embodiment can be manufactured by using a continuously cast sheet or a rolled sheet as a raw material as described above, performing plastic working, such as press forming or a secondary process such as cutting work on the raw material as appropriate, and performing diamond cut on a particular portion, and is suitable for mass production.
(8) One example of the magnesium alloy structural member (5) having the chamfered portion, the transparent coating layer, and the protective layer is as follows:

An embodiment in which the alloy substrate has a top face portion and a side face portion;

the chamfered portion is formed at a corner portion between the top face portion and the side face portion;

the top face portion or the side face portion has a protective layer; and the transparent coating layer covers the mirror-finished portion and the protective layer.

In the embodiment described above, the alloy substrate is covered with the transparent coating layer or both the transparent coating layer and the protective layer; thus, corrosion resistance is superior while highly metallic texture and an excellent design property are maintained.

### Detailed Description of Embodiments of Present Invention

Magnesium alloy structural members according to the embodiments of the present invention will now be specifically described with reference to the drawings as appropriate. In the drawings, the same reference signs denote the same parts.

### [Magnesium Alloy Structural Member]

### (Summary)

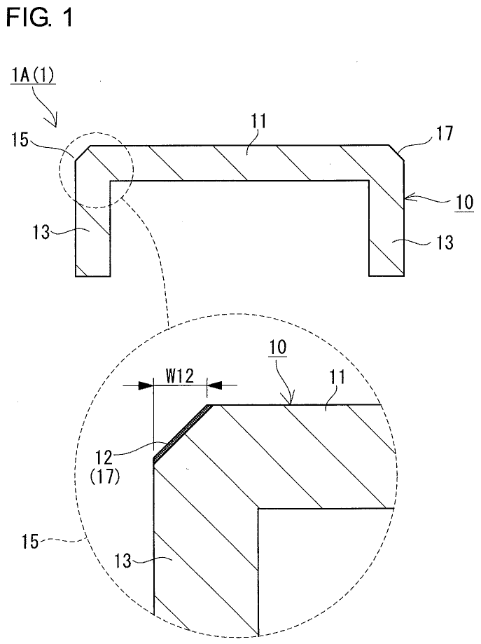

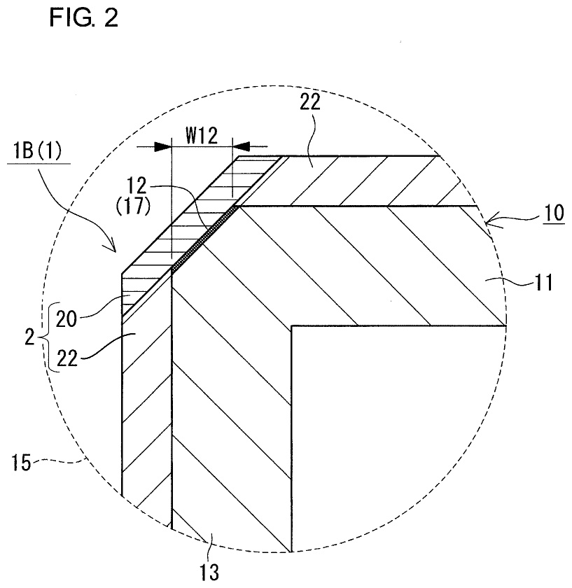

A magnesium alloy structural member 1 according to an embodiment includes an alloy substrate 10 consisting of a magnesium alloy. Representative examples of the magnesium alloy structural member include a magnesium alloy structural member 1A substantially solely formed of the alloy substrate 10 (embodiment 1, FIG. 1), and magnesium alloy structural members 1B to 1E (embodiments 2 to 5, FIGS. 2 to 5) each including an alloy substrate 10 and a coating layer 2 that covers at least part of a surface of the alloy substrate 10.

The alloy substrate 10 of the magnesium alloy structural member 1 according to the embodiment consists of a magnesium alloy corresponding to the AZ91 alloy under the ASTM standards and includes a sheet-shaped portion. FIG. 1 illustrates an example in which the entire alloy substrate 10 is formed of a sheet-shaped portion. Moreover, the alloy substrate 10 of the magnesium alloy structural member 1 of the embodiment has a surface, a part of which is a mirror-finished portion 12, and the surface roughness Ra of the mirror-finished portion 12 is less than 0.3 μm. In FIGS. 1 to 5, the region where the mirror-finished portion 12 is formed in the surface of the alloy substrate 10 is indicated by crosshatching to facilitate understanding.

Since the magnesium alloy structural member 1 of the embodiment consists of a magnesium alloy having a particular composition, includes a sheet-shaped portion, and locally has a portion where the surface roughness Ra is very small, the magnesium alloy structural member 1 offers highly metallic texture and an excellent design property. In the description below, the alloy substrate 10 and the coating layer 2 are sequentially described. In the alloy composition, the content of the individual element is indicated in terms of mass %.

### (Alloy Substrate)

### <Alloy Composition>

The magnesium alloy constituting the alloy substrate 10 contains additive elements, and the balance being Mg and unavoidable impurities, and corresponds to the AZ91 alloy under the ASTM standards in which Al is contained in a relatively large amount as an additive element. The prescribed main elements of the AZ91 alloy are Al, Mn, and Zn, and the prescribed ranges therefor are Al: 8.5% or more and 9.5% or less, Mn: 0.15% or more and 0.40% or less, and Zn: 0.45% or more and 0.9% or less. Here, in addition to compositions that satisfy the prescribed ranges of the ASTM standards, AZ91 alloy-based compositions that contain the following ranges of the following additive elements and contain Al in an amount of 8.3% or more and 9.5% or less are referred to as “corresponding to the AZ91 alloy”. The additive element is, for example, at least one element selected from Y, Ce, Ca, and rare earth elements (Y and Ce are excluded), and the total content thereof is, for example, 0.1% or more and 5% or less. The heat resistance and flame retardancy are excellent since additive elements such as Ca are contained.

### <Shape>

The alloy substrate 10 may have a flat form (not illustrated) with which a sheet directly serves as the alloy substrate 10, or have a three-dimensional form having a three-dimensional shape obtained from one sheet by bending, curving, or cutting by cutting work. For either form, a representative example is the case in which the entirety of the alloy substrate 10 is formed of a sheet-shaped portion. The three-dimensional form typically has a flat portion and a bent portion such as a corner portion or a curved portion formed by bending or curving a sheet, or a corner portion or a curved portion formed by cutting the sheet, as described above.

Examples of the alloy substrate 10 having a flat form include a sheet having a uniform thickness throughout the entirety, a sheet having a thickness that locally varies (a sheet having a groove, a sheet having a thick portion and a thin portion, or the like), and a sheet having a through hole. Examples of the planar shape of these sheets include various shapes such as a polygon such as a rectangle, and curved shapes such as a circle and an ellipse. Furthermore, these sheets may have a chamfered portion formed by C-chamfering or R-chamfering a corner portion near a ridge line thereof.

Examples of the alloy substrate 10 having a three-dimensional form include a three-dimensional object, such as a box, that has a top face portion 11 and side face portions 13 extending from the top face portion 11 illustrated as an example in FIG. 1, a polygonal prism such as a rectangular prism, and a ring-shaped closed three-dimensional object such as a curved-surface cylinder, such as a circular cylinder. A box or a polygonal prism is substantially formed of flat sheet portions and corner portions, and a curved-surface cylinder is substantially formed of a bent portion. The alloy substrates 10 illustrated in FIGS. 1 to 5 are each a shaped body that includes a corner portion 15 obtained by bending a magnesium alloy sheet at a right angle. The alloy substrate 10 having a three-dimensional form may have locally varying thickness or a through hole. The alloy substrate 10 having a three-dimensional form can have a chamfered portion 17 obtained by C-chamfering or R-chamfering a corner portion 15 obtained by bending a sheet at a particular angle or a corner portion 15 obtained by cutting a sheet at a particular angle. FIGS. 1 to 5 each illustrate an example case in which the chamfered portion 17 is obtained by C-chamfering the corner portion 15.

### <Manufacturing Embodiments>

The alloy substrate 10 is, for example, one selected from a continuously cast sheet, a rolled sheet, a shaped body of a continuously cast sheet, and a shaped body of a rolled sheet when classified according to the manufacturing process. The continuously cast sheet and the rolled sheet are examples of the flat form described above, and the shaped bodies are examples of the three-dimensional form described above.

The continuously cast sheet is preferably manufactured by a twin-roll process such as the one described in PTL 1. This is because the continuously cast sheet has substantially no or very few defects, such as shrinkage cavities, pores, and segregations, and coarse oxides and precipitates in crystal, etc., and, thus, when such a continuously cast sheet is used as a raw material and subjected to diamond cut under the particular conditions described below, a mirror-finished portion 12 having very small surface roughness Ra can be formed. Some of the possible indicators of a continuously cast sheet are that the structure is free of texture and has random orientation and that the average crystal grain diameter is 30 μm or more although this depends on the casting conditions and the subsequent heat treatment conditions, etc. The average crystal grain diameter of the continuously cast sheet or a rolled sheet described below can be measured in accordance with, for example, “Steels-Micrographic determination of the apparent grain size”, JIS G 0551 (2005). Known conditions such as those described in PTL 1 (for example, conditions described in WO 2006/003899) can be referred for the continuous casting conditions.

The rolled sheet is preferably obtained by rolling, in particular, hot-rolling, the continuously cast sheet such as the one described in PTL 1. This is because, when the continuously cast sheet is subjected to the aforementioned rolling, there occurs a fine crystal structure or a dense structure having substantially no or very few cast defects such as pores, and a mirror-finished portion 12 with very small surface roughness Ra can be formed by performing diamond cut on such a rolled sheet used as a raw material under the particular conditions described below. Furthermore, a rolled sheet having a fine crystal structure exhibits excellent mechanical properties, such as impact resistance, strength, proof stress, and elongation, and excellent corrosion resistance compared to the continuously cast sheet. In addition, a rolled sheet is easier to reduce thickness than the continuously cast sheet, and a more light-weight magnesium alloy structural member 1 can be easily formed. Some of the possible indicators of the rolled sheet are that the sheet has substantially no or very few cast defects and is dense, that the sheet has texture, that the crystal structure is fine (for example, an average crystal grain diameter of 20 μm or less or, furthermore, 5 μm or less), and that the sheet is thin (in particular, 2 mm or less or, furthermore, 1.0 mm or less). For the rolling conditions, known conditions such as those described in PTL 1 and the like (for example, raw material temperature: 150° C. to 280° C., roll temperature: 100° C. to 250° C., reduction per pass: 10% to 50%, etc.) can be referred.

The continuously cast sheet can be subjected to a heat treatment (for example, homogenization, solution treatment, or the like), polishing, or the like, after continuous casting. The rolled sheet can be subjected to a heat treatment (for example, straightening annealing or the like), a levelling process, polishing, or the like after rolling. In other words, the “continuously cast sheet” or the “rolled sheet” described above may be any sheet that has undergone the continuous casting step by the twin-roll process or a hot rolling step. One possible indicator of a polished material is that there is polishing trace. One possible indicator of a corrected material subjected to a leveling process is that the obtained structure exhibits monochromatic light X-ray diffraction peaks and has no crystal grain boundaries when observed. Some possible indicators of a heat-treated material obtained by heat-treating the rolled sheet are that no shear zone is observed inside the alloy, and that the crystal grains having a crystal grain diameter of 0.1 μm or less account for 5 area % or less in a cross-section although this depends on the heat treatment conditions. For the heat treatment conditions, polishing conditions, and the levelling process conditions, known conditions such as those described in PTL 1 (for example, polishing: wet belt polishing using abrasive grains #240 or higher, #320 or higher, and #600 or higher, leveling process: a roll leveler apparatus in which rollers are arranged in a zig-zag-pattern is used, raw material temperature: 150° C. to 280° C., etc.) can be referred.

Representative examples of the shaped body of the continuously cast sheet and the shaped body of the rolled sheet include those obtained by performing plastic working such as press forming on the continuously cast sheet or the rolled sheet. An example of the plastic working is hot processing such as one described in PTL 1. The plastic working method, the shape of the die used, etc., may be selected so that a shaped body with a particular shape is obtained. Other examples of the shaped body of the continuously cast sheet and the shaped body of the rolled sheet are those having particular three-dimensional shapes by cutting by cutting work.

When the alloy substrate 10 has a chamfered portion 17, chamfering may be performed on the continuously cast sheet, the rolled sheet, or the shaped body by cutting work, laser processing, or the like. Known conditions can be referred for the work conditions.

### <Thickness>

The thickness of the sheet-shaped portion in the alloy substrate 10 may be selected as appropriate. In particular, when the thickness is 25 mm or less or, furthermore, 15 mm or less, the coarse defects and the like generated during manufacturing can be reduced, and a mirror-finished portion 12 with very small surface roughness Ra can be easily formed accurately by performing diamond cut under particular conditions. When the alloy substrate 10 is the rolled sheet directly or a shaped body of the rolled sheet, the thickness is smaller, for example, 10 mm or less or, furthermore, 5 mm or less. The alloy substrate 10 formed of such a thin sheet is light-weight and yet has excellent impact resistance, strength, etc., as described above.

### <Mirror-Finished Portion>

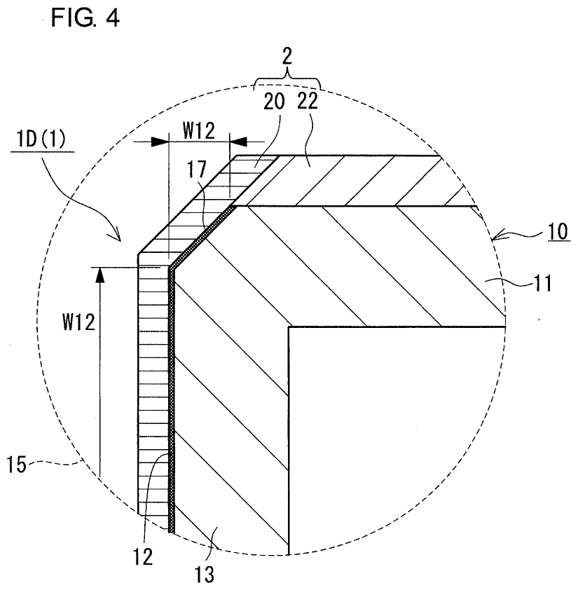

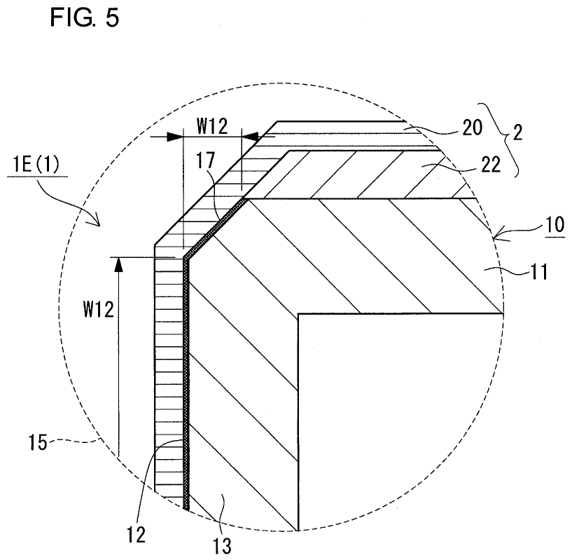

The alloy substrate 10 has a surface, a part of which is a region having a surface roughness Ra of less than 0.3 μm, and this region is the mirror-finished portion 12. This region has high glossiness. The surface of the alloy substrate 10 locally has a region where the surface roughness Ra is very small instead of having such a region in a relatively wide region, such as the entire surface of the alloy substrate 10. In particular, when the designed surface of the alloy substrate 10 is constituted by multiple faces (for example, in FIG. 1, faces such as the top face portion 11, the side face portions 13, and the chamfered portions 17), the mirror-finished portion 12 may be formed only in a small face among these faces (for example, for the box illustrated in FIG. 1, only the chamfered portion 17 or the side face portions 13), or a large face among these faces (for example, for the box illustrated in FIG. 1, the top face portion 11). FIGS. 1 to 3 illustrate examples in which the mirror-finished portion 12 is formed only in the chamfered portion 17. FIGS. 4 to 5 illustrate examples in which the mirror-finished portion 12 is formed in the chamfered portion 17 and in the side face portion 13 continuous with the chamfered portion 17. The alloy substrate 10 that locally has the mirror-finished portion 12 has highly metallic texture and has an excellent design property due to the contract between the mirror-finished portion 12 and the surrounding portion other than the mirror-finished portion 12. Since the glossiness increases as the surface roughness Ra decreases, the contrast with the surrounding portion is improved, and the design property is improved. Thus, the surface roughness Ra can be 0.2 μm or less, or, furthermore, 0.1 μm or less or less than 0.1 μm. The lower limit of the surface roughness Ra is not particularly set, but when the surface roughness Ra is 0.01 pm or more, the processing time can be easily made relatively short, and mass production is easy. When there is a coating layer 2 described below, the coating layer 2 is removed by using a reagent, such as a strong alkali, or a method appropriate for preventing damage on the surface texture of the alloy substrate 10 so as to expose the alloy substrate 10 and then the surface roughness Ra is measured.

The outline of the region where the surface roughness Ra is less than 0.3 μm (mirror-finished portion 12) can be selected as appropriate. For example, when the alloy substrate 10 has a groove or a protrusion, such as a logo, formed by carving, the mirror-finished portion 12 is formed only on the bottom surface of the groove or the top face of the protrusion, or only on the side surfaces of the groove or the protrusion. Alternatively, for example, when the alloy substrate 10 has a chamfered portion 17 obtained by C-chamfering a corner portion, the mirror-finished portion 12 may include the chamfered portion 17. In such a case, the mirror-finished portion 12 has a strip shape with a uniform width, and this strip is linearly arranged. Alternatively, for example, the mirror-finished portion 12 is a strip with a uniform width arranged to meander to form a wavy shape or a zig-zag shape, or multiple strips may be arranged to intersect one another so as to form various patterns, such as a checkered pattern or a network pattern.

When the mirror-finished portion 12 has a strip shape with a uniform width as described above, the width W12 of the mirror-finished portion 12 is, for example, 0.1 mm or more and 50 mm or less although this depends on the size of the alloy substrate 10. As long as the width W12 is 0.1 mm or more, highly metallic texture is exhibited due to the mirror-finished portion 12. The width W12 can be 0.5 mm or more, 1 mm or more, or 5 mm or more. As long as the width W12 is 50 mm or less, the contrast between the mirror-finished portion 12 and the surrounding portion can be improved, and the design property is improved. When the chamfered portion 17 obtained by C-chamfering is the mirror-finished portion 12, the width W12 refers to the chamfer dimension of C-chamfering (the distance between one of the two faces that form the corner portion 15 to a boundary between the other face and a sloped face formed by C-chamfering (see FIG. 1)). When there are multiple strip-shaped mirror-finished portions 12, the width W12 of each mirror-finished portion 12 satisfies the above-described range, for example. In such a case, the widths W12 of the mirror-finished portions 12 may be the same or different from each other.

The mirror-finished portion 12 having a surface roughness Ra of less than 0.3 μm is typically formed by performing diamond cut on a particular region of the alloy substrate 10. The results of the studies conducted by the inventors of the present invention have found that it is preferable to use a cutting tool (typically an endmill) that has a cutting edge formed of single crystal diamond, to set the cutting velocity V (m/min) to a relatively high level, and to set the feed rate f per revolution (mm/rev.) to a relatively low level. The cutting velocity V (circumferential velocity) is expressed by V=D×N×π/1000 where D (mm) is the endmill diameter, N (rpm) is the number of revolutions of the endmill per minute, and π is the ratio of the circumference of a circle to its diameter. The feed rate f per revolution is expressed by f=F/N where F (mm/min) is the table feed rate and N (rpm) is as described above. The cutting velocity V is, for example, 400 m/min or more or, furthermore, 500 m/min or more or 600 m/min or more. The feed rate f per revolution is, for example, 0.05 mm/min or less, 0.04 mm/min or less, or 0.03 mm/min or less.

When the chamfered portion 17 is to be the mirror-finished portion 12, the chamfering itself can be performed by diamond cut. Meanwhile, it is suitable for mass production to perform diamond cut under the aforementioned conditions as the finishing process after chamfering with a common cutting tool formed of cemented carbide or the like.

### (Coating Layer)

The magnesium alloy structural member 1 of the embodiment exhibits excellent corrosion resistance when it includes, in addition to the alloy substrate 10, a coating layer 2 which covers at least part of the surface of the alloy substrate 10. The coating layer 2 has a tendency to exhibit higher corrosion resistance when the number of layers stacked is large or when the total thickness is large. Moreover, the larger the region of the surface of the alloy substrate 10 where the coating layer 2 is formed, the higher the corrosion resistance, and forming the coating layer 2 on the entire surface of the alloy substrate 10 further improves corrosion resistance. In particular, when the designed surface of the alloy substrate 10 has a transparent coating layer 2, the design property is excellent while exhibiting highly metallic texture, and corrosion resistance is also excellent.

Examples of the coating layer 2 include layers formed by various forming methods using various coating materials. Examples of the coating materials include organic materials such as epoxy resins, acrylic resins, and urethane resins, and mixtures of these organic materials and various additive materials. Examples of the additive materials include insulating materials such as SiO₂ and powder formed of an electrically conductive material such as Al. When such additive material powder is contained, a coating layer 2 having tactile feel and visual feel can be formed. For example, the average particle diameter of the SiO₂ powder is 0.2 μm or more and 50 μm or less, and the SiO₂ powder content is 0.5 vol % or more and 30 vol % or less. Examples of the forming methods include spraying, electrodeposition, and electrostatic coating. Known coating materials and forming methods may be utilized.

The coating layer 2 can include an anticorrosive layer (not illustrated) formed by performing an anticorrosion treatment, such as a chemical conversion treatment, an anodization treatment, or the like, directly on the alloy substrate 10. In this case, the corrosion resistance is improved. Furthermore, an effect of enhancing the adhesion between the alloy substrate 10 and another layer formed on the anticorrosive layer can be expected by providing the anticorrosive layer. However, it is possible that the surface roughness Ra is affected depending on the conditions of the anticorrosion treatment. Thus, for example, the anticorrosive layer formed by the anticorrosion treatment is provided not directly on the mirror-finished portion 12 but on the surrounding portion other than the mirror-finished portion 12.

The material, the thickness, the number of layers stacked, the forming method, etc., of the coating layer 2 may be selected as appropriate. In addition, the material, the thickness, the number of layers stacked, the forming method, etc., of the coating layer 2 may be different from one part to another. When the coating layer 2 is to be locally provided, the portions where the coating layer 2 is not needed are masked as appropriate, and the coating layer 2 is formed in the predetermined region, for example.

The color, the transmittance, etc., of the coating layer 2 may also be selected as appropriate. For example, the design property can be improved when the coating layer 2 has portions of different colors or layers with single-color or multiple-color patterns. Alternatively, for example, when the coating layer 2 has a colorless or transparent color portion and an opaque color portion, the metallic texture of the alloy substrate 10 can be recognized through the transparent portion, and thus the design property can be improved while enhancing the metallic texture.

In particular, when the coating layer 2 includes a transparent coating layer 20 (FIG. 2 etc.) covering the mirror-finished portion 12, the corrosion resistance is improved, the metallic luster from the mirror-finished portion 12 can be recognized, and thus the design property can be improved while exhibiting highly metallic texture. The transparent coating layer 20 is to have a transmittance at which the alloy substrate 10 can be visually observed and the metallic luster can be recognized through this layer, and may be colored or colorless. When the transparent coating layer 20 is formed of, among the coating materials described above, a material having a higher transmittance or a material having a low haze value (measurement sample thickness in the range of 30 μm or less) of 80% or less, 50% or less, 5% or less, or ideally zero, the influence of the transparent coating layer 20 is suppressed, and thus metallic luster from the mirror-finished portion 12 can be expected to be satisfactorily recognized. Such a transparent coating layer 20 may be disposed directly above the mirror-finished portion 12.

As in a magnesium alloy structural member 1B of embodiment 2 illustrated in FIG. 2, the coating layer 2 preferably includes a transparent coating layer 20 that continuously covers the mirror-finished portion 12 and the portions adjacent to the mirror-finished portion 12, since corrosion resistance is improved. This is because penetration of moisture, sweat, or the like from the boundaries between the mirror-finished portion 12 and the portions adjacent thereto can be prevented, and corrosion near the boundary can be prevented. This magnesium alloy structural member 1B of embodiment 2 can offer highly metallic texture and an excellent design property for a long period of time.

In FIG. 2, the portions adjacent to the mirror-finished portion 12 are not the alloy substrate 10 but part of the coating layer 2 (protective layer 22). FIG. 2 illustrates an example case in which there are a protective layer 22 that covers the two faces that connect to the chamfered portion 17 (here, this portion also serves as the mirror-finished portion 12) of the alloy substrate 10 but does not cover the chamfered portion 17, and a transparent coating layer 20 that continuously covers the chamfered portion 17 and part of the protective layer 22. Specifically, the protective layer 22 covers one face (top face) of the top face portion 11 and one face (left face) of the side face portions 13, which are the surrounding portions other than the mirror-finished portion 12 in the alloy substrate 10. The transparent coating layer 20 continuously covers the chamfered portion 17, which serves as the mirror-finished portion 12 and is exposed without being covered by the protective layer 22, in the alloy substrate 10, and the portions in the protective layer 22 adjacent to the chamfered portion 17. The portions in the protective layer 22 adjacent to the chamfered portion 17 are, for example, sections obtained by partially cutting the protective layer 22 after the protective layer 22 is formed in the manufacturing process. In the magnesium alloy structural member 1B, moisture, sweat, and the like do not easily penetrate near the boundary between the protective layer 22 and the mirror-finished portion 12, which is exposed from the protective layer 22, in the alloy substrate 10, and thus corrosion near the boundary can be prevented. Moreover, when the transparent coating layer 20 and the protective layer 22 are formed of organic materials as described above, the adhesion is excellent. Thus, even when the surface roughness Ra of the mirror-finished portion 12 is very small and the adhesion strength with the coating layer 2 in the mirror-finished portion 12 is small, at least part of the transparent coating layer 20 adheres to the protective layer 22 as illustrated in FIGS. 2 to 5, and thus separation of the transparent coating layer 20 can be suppressed as a whole. As a result, the state in which the mirror-finished portion 12 is covered with the transparent coating layer 20 can be satisfactorily maintained, and the corrosion resistance is improved. When the aforementioned anticorrosive layer is provided as the lower layer of the protective layer 22, adhesion can be further improved, and corrosion resistance can be improved.

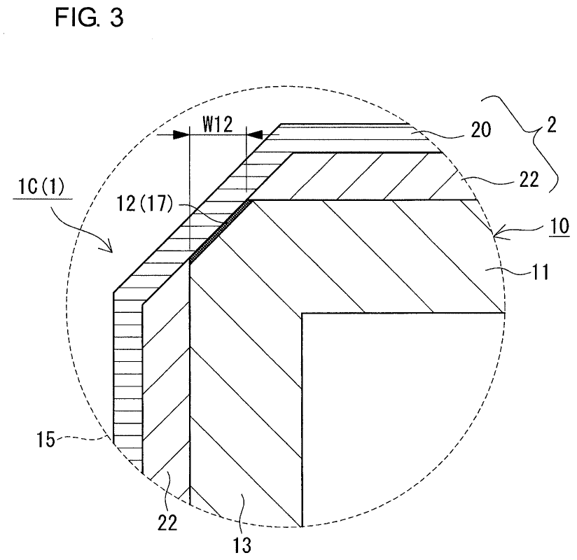

As in a magnesium alloy structural member 1C of embodiment 3 illustrated in FIG. 3, the coating layer 2 preferably includes a transparent coating layer 20 that continuously covers the chamfered portion 17 (here, also serves as the mirror-finished portion 12) in the alloy substrate 10 and the entire protective layer 22, since the corrosion resistance is further improved. In the magnesium alloy structural member 1C, the protective layer 22 covers, as in embodiment 2, the upper face and the left face, which are surrounding portions other than the mirror-finished portion 12 (chamfered portion 17) in the alloy substrate 10. The transparent coating layer 20 covers the mirror-finished portion 12 (chamfered portion 17), which is exposed without being covered by the protective layer 22 in the alloy substrate 10, and the entirety of the protective layer 22.

Magnesium alloy structural members 1D and 1E of embodiments 4 and 5 illustrated in FIGS. 4 and 5 are examples in which multiple faces that constitute the surface of the alloy substrate 10 are equipped with the mirror-finished portion 12. Specifically, in the magnesium alloy structural members 1D and 1E, the mirror-finished portion 12 includes the chamfered portion 17 and the surface of the side face portion 13 (left face). Here, the area of the side face portion 13 is typically smaller than the area of the top face portion 11. In particular, as long as the length of the side face portion 13 (length of the portion projecting from the top face portion 11) is 50 mm or less, the mirror-finished portion 12 can have a strip shape with a width W12 of 50 mm or less even when the entire surface (left face) of the side face portion 13 is formed as the mirror-finished portion 12. If the length of the side face portion 13 is more than 50 mm, for example, the mirror-finished portion 12 in the side face portion 13 may have a strip shape with a width W12 of 50 mm or less. In any case, the contrast between the mirror-finished portion 12 and the surrounding portion other than the mirror-finished portion 12 can be improved, and an excellent design property is achieved while exhibiting highly metallic texture.

In the magnesium alloy structural member 1D illustrated in FIG. 4, the coating layer 2 includes a transparent coating layer 20 that continuously covers the chamfered portion 17 and the side face portion 13 that constitute the mirror-finished portion 12, and a part (typically, the above-described section) of the protective layer 22 that covers the surface (upper face) of the top face portion 11. In the magnesium alloy structural member 1E illustrated in FIG. 5, the coating layer 2 includes a transparent coating layer 20 that covers the chamfered portion 17 and the side face portion 13 that constitute the mirror-finished portion 12, and the entirety of the protective layer 22 that covers the surface (upper face) of the top face portion 11. Thus, for the same reasons as those in embodiments 2 and 3, the magnesium alloy structural members 1D and 1E of embodiments 4 and 5 exhibit excellent corrosion resistance.

When there is a protective layer 22, the color, the transmittance, etc., of the protective layer 22 can be different from those of the transparent coating layer 20. For example, the protective layer 22 can be a semi-transparent or opaque layer. In such a case, while the metallic texture of the mirror-finished portion 12 visible through the transparent coating layer 20 is maintained, the design property is improved due to the presence of the coating layer 2. In particular, when the protective layer 22 is an opaque color layer, the metallic texture can be further improved due to the contrast between the mirror-finished portion 12 having metallic luster visible through the transparent coating layer 20 and the opaque color protective layer 22, and the design property is improved.

The portion adjacent to the mirror-finished portion 12 can be the surrounding portion in the alloy substrate 10 other than the mirror-finished portion 12. In other words, a transparent coating layer 20 that continuously extends over the mirror-finished portion 12 in the alloy substrate 10 and the portion adjacent to the mirror-finished portion 12 in the alloy substrate 10 can be provided (not illustrated in the drawings). In such a case, although the mirror-finished portion 12 and the surrounding portion of the alloy substrate 10 are covered with the uniform transparent coating layer 20, the surface roughness Ra of the surrounding portion is 0.3 μm or more. In some cases, the surface roughness Ra of the surrounding portion may be 0.5 μm or more or, furthermore, 1 μm or more or 5 μm or more when the manufacturing conditions are adjusted or the surface processing such as etching or a blast treatment is performed as appropriate. Thus, the glossy state differs between the mirror-finished portion 12 and the surrounding portion other than this, and highly metallic texture and an excellent design property can be exhibited. Moreover, the transparent coating layer 20 adheres to the surrounding portion and becomes inseparable as a whole; thus, the state of the coverage of the mirror-finished portion 12 can be satisfactorily maintained, and corrosion resistance is improved. When the aforementioned anticorrosive layer is provided in the surrounding portion, the adhesion can be further improved, and the corrosion resistance can be further improved.

The thickness of the transparent coating layer 20 covering the mirror-finished portion 12 in the alloy substrate 10 is, for example, 3 μm or more and 30 μm or less or, furthermore, 5 μm or more and 25 μm or less. Within this range, the metallic luster of the mirror-finished portion 12 can be satisfactorily recognized, and corrosion resistance is excellent. The thickness of the transparent coating layer 20 covering the mirror-finished portion 12 is typically uniform throughout the entirety, for example. The thickness of the protective layer 22 covering the surrounding portion other than the mirror-finished portion 12 in the alloy substrate 10 may be about the same as the thickness of the transparent coating layer 20, may be larger (for example, about 25 μm or more and 150 μm or less, FIGS. 2 to 5), or may be smaller (for example, about 1 μm or more and 3 μm or less). In other words, the coating layer 2 may include layers of different thicknesses. The thicknesses of the transparent coating layer 20 and the protective layer 22 are, for example, average values measured from an image of a cross section of the magnesium alloy structural member 1 observed with an optical microscope.

### [Method for Manufacturing Magnesium Alloy Structural Member]

The magnesium alloy structural member 1A of embodiment 1 not equipped with the coating layer 2 can be manufactured by, for example, performing diamond cut on a particular region of the alloy substrate 10 as described above under the aforementioned particular conditions.

The magnesium alloy structural members 1B to 1E of embodiments 2 to 5 equipped with a coating layer 2 can be manufactured though the following steps (a) to (e), for example. In the process described below, an anticorrosive layer can be formed in a particular region of the alloy substrate 10 before forming the protective layer 22.

(a) A step of preparing an alloy substrate 10.

(b) A step of forming a protective layer 22 in a particular region of the alloy substrate 10.

(c) A step of cutting and removing a part of the protective layer 22 and a part of the alloy substrate 10. For example, chamfering is performed also on the protective layer 22.

(d) A step of performing diamond cut on a portion of the alloy substrate 10 exposing from the protective layer 22 under the aforementioned particular conditions. Due to this step, the exposed portion can become the mirror-finished portion 12.

(e) A step of forming a transparent coating layer 20 continuously extending over the mirror-finished portion 12 subjected to the diamond cut, and a portion in the protective layer 22 adjacent to the mirror-finished portion 12.

### (Main Effects)

Since a part of the alloy substrate 10 of the magnesium alloy structural member 1 of the embodiment includes a mirror-finished portion 12 having a surface roughness Ra of less than 0.3 μm and having metallic luster, the mirror-finished portion 12 offers highly metallic texture while an excellent design property is achieved due to the contrast between the mirror-finished portion 12 and the surrounding portion other than the mirror-finished portion 12. Moreover, since the alloy substrate 10 consists of a magnesium alloy corresponding to the AZ91 alloy, corrosion resistance and strength are also excellent. When the coating layer 2 is provided, corrosion resistance is further improved. Furthermore, since the alloy substrate 10 includes the sheet-shaped portion consisting of the magnesium alloy corresponding to the AZ91 alloy, the alloy substrate 10 can be manufactured by using, typically, a continuously cast sheet or rolled sheet corresponding to the AZ91 alloy as the raw material and by performing the particular diamond cut described above on this raw material. Thus, manufacturability is also excellent. The above-described effects are specifically described through Experimental Examples 1 and 2 below.

### Experimental Example 1

Alloy substrates consisting of a magnesium alloy corresponding to the AZ91 alloy under the ASTM standards were prepared, diamond cut was performed on a part of each alloy substrate under various conditions, and the surface roughness Ra of the diamond cut portion was investigated. A magnesium alloy structural member obtained by forming a coating layer on an alloy substrate was studied to find adhesion of the coating layer, corrosion resistance, etc.

### (Description of Samples)

A magnesium alloy sheet corresponding to the AZ91 alloy serving as the alloy substrate was subjected to press forming to bend at a right angle so as to prepare a rectangular parallelepiped box (housing sample) having a top face portion and side face portions extending from the top face portion. The thickness of the magnesium alloy sheet was 1 mm, the size of the top face portion was 80 mm×80 mm, the length of the side face portions was 4 mm, and the planar shape was square. The magnesium alloy sheet was a rolled sheet obtained by hot-rolling a continuously cast sheet produced by a twin-roll process, and can be subjected to a leveling process, polishing, or the like, as appropriate.

A coating layer is formed on the alloy substrate as described below are diamond cut is performed.

First, an anticorrosive layer is formed by performing a chemical conversion treatment on the entire surface of the alloy substrate.

Next, a resin layer having a multilayer structure is formed on the anticorrosive layer by spray coating. Here, in the order from the inside, an epoxy resin layer (thickness: 10 μm) and an acrylic resin layer (thickness: 15 μm) containing Al powder (average particle diameter: 10 μm) and SiO₂ (average particle diameter: 1 μm) at a volume ratio of 1:1 are formed.

Next, corner portions between the top face portion and the side face portions of a first intermediate material that includes the anticorrosive layer and the aforementioned two resin layers on the entire surface of the alloy substrate are C-chamfered so as to partly remove the anticorrosive layer and the resin layers and partly expose the alloy substrate.

The exposed portions are subjected to diamond cut. Here, the C-chamfering dimension is set at 1.0 mm, and after C-chamfering is performed by cutting work or the like, diamond cut is performed by using an endmill under the conditions indicated in Table 1. Table 1 indicates the type of diamond (single crystal or polycrystal) constituting the cutting edge, the cutting velocity V (m/min), the feed rate f per revolution (mm/rev.), and the number N of revolutions of the endmill (rpm).

Next, a transparent coating layer is formed by spray coating on a second intermediate material that includes the diamond cut portion and the portions adjacent thereto constituting the sections of the anticorrosive layer and the two resin layers so that the transparent coating layer covers the diamond cut portion and at least the aforementioned sections. Here, the transparent coating layer is a transparent acrylic resin layer (thickness: 15 μm). Due to this step, magnesium alloy structural members (sample Nos. 1-1, 1-2, 1-101, and 1-102) in which the transparent coating layer is formed on the entire surface of the second intermediate material, the diamond cut portion of the alloy substrate is covered with the transparent coating layer, and the surrounding portion other than the diamond cut portion is covered with the anticorrosive layer, the two resin layers (corresponding to the protective layer), and the transparent coating layer are obtained.

In sample Nos. 1-1 and 1-2, a cutting edge formed of single crystal diamond is used, the cutting velocity V is set at 700 m/min or more, and the feed rate f per revolution is set at 0.02 mm/rev. or less (high speed, low feed). In sample No. 1-2, the cutting velocity V is set at 1000 m/min or more so that the speed is higher.

In sample No. 1-101, a cutting edge formed of single crystal diamond is used as in sample No. 1-1, but the cutting velocity V is set at 380 m/min or less, and the feed rate f per revolution is set at 0.08 mm/rev. or more (low speed, high feed).

In sample No. 1-102, the high-speed, low-feed condition is the same as in sample No. 1-1, but a cutting edge formed of polycrystal diamond is used.

### (Evaluation)

For sample Nos. 1-1, 1-2, 1-101, and 1-102, the surface roughness of the diamond cut portion was measured after the diamond cut and before formation of the transparent coating layer described above. The results are indicated in Table 1. Here, a commercially available surface roughness meter (SURFCOM 130A produced by TOKYO SEIMITSU CO., LTD.) was used to determine the arithmetic mean roughness Ra (μm) of the entirety of the diamond cut portion.

The following (1) to (3) were studied for the magnesium alloy structural members of sample Nos. 1-1 and 1-2.

### (1) Adhesion

(1-1 Cross-cut test) This test is performed in accordance with the cross-cut method under JIS K 5600-5-6 (1999), and whether there is separation of the coating layer (here, mainly the transparent coating layer and the protective layer) is investigated.

(1-2 Hot water test) This test involves immersing each sample in 70° C. hot water for 1 hour, and then performing the cross-cut test as described above (1-1 Cross-cut test), and whether there is separation of the coating layer is investigated.

(1-3 Heat cycle test) In this test, one cycle is constituted by a total of 24 hours of the following low-temperature retention and high-temperature retention and the following temperature increase time and the temperature decrease time. In low-temperature retention, a low-temperature state at −30° C. is retained for 10 hours. In high-temperature retention, a high-temperature state at 70° C. and a humidity of 90% is retained for 10 hours. Under these conditions, after three cycles, the cross-cut test is performed as described above (1-1 Cross-cut test), and whether there is separation of the coating layer is investigated.

### (2) Corrosion Resistance

### (2-1 Salt Spray Test)

This test involves spraying a 5 mass % NaCl aqueous solution toward each of the samples, and after the samples are held at 35° C. for 96 hours, presence or absence of corrosion in the alloy substrate and the presence or absence of a change in color in the alloy substrate are investigated.

### (2-2 Heat Cycle Test)

After the above-described (1-3 Heat cycle test), presence or absence of corrosion of the alloy substrate and the presence or absence of a change in color in the alloy substrate are investigated as in the above-described (2-1 Salt spray test).

### (3) Alcohol Resistance

This test is performed in accordance with the rubbing tester II (method of Committee of the Japan Society for the Promotion of Sciences) method prescribed in JIS L 0849 (2013). A cotton cloth impregnated with ethanol having a concentration of 99.5 mass % is attached to a rubbing finger, a load of 1 kg/cm² is applied by this rubbing finger (for white cloth, curved type with surface radius: 45 mm, 20 mm×20 mm (contact area: 100 mm²)), and reciprocating rubbing motion is performed at a stroke of 25 mm, velocity of 29 times/min, and the number of reciprocating rubbing motion of 100. After this reciprocating rubbing motion, the presence or absence of a change in color in the coating layer and whether there are abnormalities in the surface texture of the coating layer are investigated. Here, the top face portion covered with the transparent coating layer is allowed to contact the rubbing finger. For the reciprocating rubbing motion, a commercially available tester (for example, 821C-L produced by Coating Tester Kabushiki Kaisha) can be used.

TABLE 1

| Sample No. | 1-101 | 1-1 | 1-102 | 1-2 |
|---|---|---|---|---|
| Diamond cut shape | Ridge line C- | Ridge line C- | Ridge line C- | Ridge line C- |
| Chamfer dimension | chamfering | chamfering | chamfering | chamfering |
| | C 1.0 mm | C 1.0 mm | C 1.0 mm | C 1.0 mm |
| Diamond type | Single crystal | Single crystal | Polycrystal | Single crystal |
| Tool revolution | 6000 | 12000 | 12000 | 18000 |
| number N (rpm) | | | | |
| Cutting velocity V | 377 | 754 | 754 | 1131 |
| (m/min) | | | | |
| Feed rate f per | 0.083 | 0.017 | 0.017 | 0.017 |
| revolution (mm/rev.) | | | | |
| Surface roughness Ra | 0.350 | 0.088 | 0.332 | 0.033 |
| (μm) | | | | |

As indicated in Table 1, the magnesium alloy structural members of sample Nos. 1-1 and 1-2 have a surface roughness Ra of less than 0.3 μm at the chamfered portion obtained by C-chamfering. In sample No. 1-1, the surface roughness Ra is 0.1 μm or less, and furthermore, as small as 0.09 μm or less, which is about one fourth or less of those of the sample Nos. 1-101 and 1-102. In sample No. 1-2, the surface roughness Ra is 0.05 μm or less, which is further smaller than that of sample No. 1-1. The chamfered portions of sample Nos. 1-1 and 1-2 are considered to be mirror-finished portions having high glossiness. The chamfered portion of sample No. 1-2 is considered to be a mirror-finished portion having higher glossiness. In addition, in the magnesium alloy structural members of sample Nos. 1-1 and 1-2, the chamfered portion (a strip shape with a width of 1.0 mm) is the only region having a very small surface roughness Ra, and the surface roughness Ra of the surrounding portion other than the chamfered portion is 0.3 μm or more. Thus, these members have the mirror-finished portion locally. Moreover, the coating layer that covers the mirror-finished portion is a transparent coating layer, and thus the metallic luster can be satisfactorily sensed. Furthermore, the coating layer on the surrounding portion other than the mirror-finished portion includes a protective layer different from the transparent coating layer so that the contrast between the mirror-finished portion and other portion can be strongly recognized. Thus, the magnesium alloy structural members of sample Nos. 1-1 and 1-2 has highly metallic texture due to the mirror-finished portion, and has an excellent design property due to the contrast between the mirror-finished portion and the surrounding portion other than the mirror-finished portion. The sample No. 1-2 having a smaller surface roughness Ra has both higher metallic texture and superior design.

The sample Nos. 1-1 and 1-2 did not undergo separation of the coating layer in (1) adhesion test, and thus the coating layer has excellent adhesion. A possible reason therefor is that the transparent coating layer covering the mirror-finished portion also continuously covers the aforementioned two resin layers and thus the resins could adhere to each other. Furthermore, sample Nos. 1-1 and 1-2 did not undergo corrosion or a change in color in the alloy substrates in (2) Corrosion resistance tests, and have excellent corrosion resistance. Possible reasons therefor are that the alloy substrate consists of a magnesium alloy corresponding to the AZ91 alloy, that there is a coating layer, that the transparent coating layer that covers the mirror-finished portion also continuously covers the aforementioned two resin layers described above, and that a rolled sheet obtained by hot-rolling a continuously cast sheet is used as a raw material so as to reduce or eliminate defects, such as cast defects. In addition, sample Nos. 1-1 and 1-2 did not undergo a change in color in the coating layer in (3) alcohol resistance test, abnormality is not observed in the surface texture, and thus these samples are considered to have a coating layer having excellent alcohol resistance.

Furthermore, it was demonstrated that a magnesium alloy structural member having an excellent design property while exhibiting highly metallic texture as described above can be manufactured by using a sheet consisting of a magnesium alloy corresponding to the AZ91 alloy under the ASTM standards, in particular, a rolled sheet obtained by hot-rolling a continuously cast sheet produced by a twin-roll process, as a raw material and by subjecting this raw material to diamond cut under particular high-speed, low-feed conditions, by using a cutting edge formed of single crystal diamond. Moreover, it was demonstrated that the corrosion resistance is excellent and the adhesion of the coating layer is also excellent when a part of the alloy substrate is exposed by cutting after formation of a coating layer on the alloy substrate and by forming a different coating layer that covers the exposed portion of the alloy substrate and the sections of the coating layer.

### Experimental Example 2

Corrosion resistance was investigated for magnesium alloy structural members having diamond cut portions having different surface roughness Ra.

A magnesium alloy structural member was manufactured as in Experimental Example I except that a box sample manufactured as in Experimental Example 1 was prepared as the alloy substrate consisting of a magnesium alloy corresponding to the AZ91 alloy under the ASTM standards, the diamond cut conditions were changed to the following conditions, and the thickness of the transparent coating layer on the diamond cut portion was changed to 8 μm.

In sample Nos. 2-1 and 2-4, diamond cut is performed by using a cutting edge formed of single crystal diamond under the conditions that the cutting velocity V is selected from the range of 400 m/min or more, and the feed rate f per revolution is selected from the range of 0.05 mm/rev. or less. The conditions for sample No. 2-1 are about the same as those for sample No. 1-1 in Experimental Example 1.

For sample No. 2-101, diamond cut is performed under the same conditions as those for sample No. 1-101 in Experimental Example 1.

The surface roughness Ra of the diamond cut portion was measured before formation of the transparent coating layer as in Experimental Example 1. The results are indicated in Table 2.

After formation of the transparent coating layer, the magnesium alloy structural member having the coating layer is examined as to the presence or absence of corrosion in the alloy substrate and a change in color in the alloy substrate as in (2-1 Salt spray test) of Experimental Example 1. In this test, the salt spray test retention time is 48 hours, 72 hours, and 96 hours as indicated in Table 2, and the results are indicated in Table 2. Samples with no corrosion or change in color are considered to have excellent corrosion resistance and are evaluated as “good”, and samples with corrosion or a change in color are indicated so in Table 2.

TABLE 2

| Sample No. | 2-1 | 2-2 | 2-3 | 2-4 | 2-101 |
|---|---|---|---|---|---|
| Surface | 0.08 | 0.17 | 0.23 | 0.29 | 0.35 |
| roughness | | | | | |
| Ra (μm) | | | | | |
| Salt spray | Good | Good | Good | Good | Good |
| 48 Hr | | | | | |
| Salt spray | Good | Good | Good | Good | Change in |
| 72 Hr | | | | | color observed |
| | | | | | in some part |
| Salt spray | Good | Change in | Change in | Change in | Change in |
| 96 Hr | | color observed | color observed | color observed | color observed |
| | | in some part | in some part | in some part | in substantially |
| | | | | | entire surface |

As indicated in Table 2, all of sample Nos. 2-1 to 2-4 in which the surface roughness Ra of the diamond cut portion is less than 0.3 μm did not undergo corrosion or a change in color in the salt spray test with a retention time of 72 hours, and this indicates that the corrosion resistance is excellent. In particular, sample No. 2-1 having a surface roughness Ra of 0.1 μm or less did not undergo corrosion or a change in color in the salt spray test with a retention time of 96 hours, and this indicates that the corrosion resistance is superior. Here, the corrosion resistance required for typical housings is that corrosion or a change in color does not occur in the salt spray test with a retention of 72 hours. Thus, all of sample Nos. 2-1 to 2-4 are considered to be suitable for typical housings. In particular, sample No. 2-1 has superior corrosion resistance, and is considered to be suitable for housing products required to exhibit higher corrosion resistance reliability. This test indicates that a surface roughness Ra of 0.1 μm can improve the corrosion resistance reliability. One of the reasons why small surface roughness Ra improves the corrosion resistance is that the increase in surface area attributable to minute irregularities can be reduced and thus the increase in contact area with the corrosive factor can be reduced. Moreover, this test indicates that sample Nos. 1-1 and 1-2 of Experimental Example 1 described above in which the surface roughness Ra is 0.1 μm or less are considered to improve the corrosion resistance reliability.

The present invention is not limited by these examples but is defined by the claims, and is intended to include all modifications and alterations within the meaning and scope of the claims and equivalents thereof.

For example, in Experimental Examples 1 and 2, the anticorrosive layer may be omitted or the resin layers may be formed by electrodeposition.

### REFERENCE SIGNS LIST

1, 1A, 1B, 1C, 1D, 1E magnesium alloy structural member

10 alloy substrate

11 top face portion

12 mirror-finished portion

13 side face portion

15 corner portion

17 chamfered portion

2 coating layer

20 transparent coating layer

22 protective layer

1. A magnesium alloy structural member comprising:
an alloy substrate that includes a sheet-shaped portion consisting of a magnesium alloy corresponding to an AZ91 alloy under the standards of American Society for Testing and Materials,
wherein the alloy substrate has a surface, a part of which is a mirror-finished portion having a surface roughness Ra of less than 0.3 μm.

2. The magnesium alloy structural member according to claim 1, wherein the mirror-finished portion has a strip shape with a uniform width, and this width is 0.1 mm or more and 50 mm or less.

3. The magnesium alloy structural member according to claim 1, comprising a transparent coating layer that continuously covers the mirror-finished portion and a portion adjacent to the mirror-finished portion.

4. The magnesium alloy structural member according to any claim 1, wherein the mirror-finished portion includes a chamfered portion obtained by C-chamfering a corner portion of the alloy substrate.

5. The magnesium alloy structural member according to claim 4, comprising:
a protective layer that covers at least part of two faces that connect to the chamfered portion of the alloy substrate, but does not cover the chamfered portion; and
a transparent coating layer that continuously covers the chamfered portion and at least part of the protective layer.

6. The magnesium alloy structural member according to claim 5, wherein the transparent coating layer continuously covers the chamfered portion and the entirety of the protective layer.

7. The magnesium alloy structural member according to claim 1, wherein the alloy substrate is one selected from a shaped body of a rolled sheet, a rolled sheet, a continuously cast sheet, and a shaped body of a continuously cast sheet.

8. The magnesium alloy structural member according to claim 5, wherein:
the alloy substrate has a top face portion and a side face portion;
the chamfered portion is formed at a corner portion between the top face portion and the side face portion;
the top face portion or the side face portion has a protective layer; and
the transparent coating layer covers the mirror-finished portion and the protective layer.
